(19) United States
(12) Patent Application Publication
(10) Pub. No.: US 2010/0101143 A1
(43) Pub. Date: Apr. 29, 2010

(54) Plant pot hanger

(76) Inventors: R. Giovanni Fima, Ocenaside, CA (US); Antony C. Tangorra, El Cajon, CA (US)

Correspondence Address: CATALYST LAW GROUP, APC, 9710 SCRANTON ROAD, SUITE S-170, SAN DIEGO, CA, 92121, US

(21) Appl. No.: 12/587,997

(22) Filed: Oct. 14, 2009

Related U.S. Application Data
(60) Provisional application No. 61/196,075, filed on Oct. 14, 2008.

(51) Int. Cl. A01G 9/02

(52) U.S. Cl. 47/65.5

(57) ABSTRACT

An apparatus designed to securely hang any size pot to all types of fences, for the purpose of growing flowers or various vegetable plants off the ground and in confined areas. The fence pot hanger can be manufactured to a preset pot size with no adjustments, or can be manufactured with an adjustable spring rim holder that fits and slides over the top hanger main body and locks at a desired height to accommodate larger or small pots. By pushing the spring lever back, causes the pot rim holder to move up or down and firmly secures the rim holder inside the pot. There are additional holes in the main fence pot hanger to provide secure anchor by way of securing the pot to the hanger main body using nylon straps or other means while providing additional drain holes to the pot. This can prevent accidental mishaps when accidentally nudged or possibly strong winds.

### RELATED APPLICATION

This application claims the benefit of priority to U.S. Provisional Application Ser. No. 61/196,075 for an invention entitled “Plant Pot Hanger” filed Oct. 14, 2008, and currently co-pending.

### FIELD OF THE INVENTION

The present invention relates generally to pots used for agriculture. The present invention is more particularly, though not exclusively, useful as a portable pot and pot support system for removably attaching a pot to a fence, wall, or other structure.

### BACKGROUND OF THE INVENTION

As the population continues to rise, and the area for housing becomes increasingly scarce, it has become difficult to obtain sufficient ground space for a traditional garden. For instance, most apartments and condominiums have little or no area suitable for gardening. In fact, most track home developments have little or no open space as the builders tend to maximize the size of the structure in lieu of any sizeable open space. As a result, those living in densely populated urban environments are often unable to practice gardening or to enjoy the many benefits of abundant foliage, such as the increase in daytime oxygen, the calming effects of plants and the natural aesthetic appearances.

In addition to the decrease in available ground space, it has also been reported that some plants actually fare better when grown in pots. There are many reasons for this, including the ability to precisely control the soil environment, amount of water delivered, and ability to relocate the plant without disruption to its root structures.

Up to now, the typical approach to gardening in urban areas was to place planters upon the patio or porch, or on window sills inside the home. While this did provide some plant life for the occupant, the space suitable for such planters is often limited.

In light of the above, it would be advantageous to provide a solution to urban gardening that facilitates use of previously unavailable locations for growing plants. It would also be advantageous to provide a gardening solution that is easily relocated in order to provide optimal light, and which can be readily moved from inside to outside depending on the plant's requirements. It would also be advantageous to provide a device which is universal in nature and capable of use on outdoor wood fences, walls, lattice work, chain link fences, as well as interior cubicle walls, doors, etc.

### SUMMARY OF THE INVENTION

The present invention includes a pot hanging device and a removable pot. The pot hanging device includes a vertical hanger having an open upper hook portion which is designed to accept and retain the device on a variety of supports, such as fences, cubicle walls, chain link fences, wood fences, lattice work, etc.

A pot support pad is mounted to the bottom portion of the device and designed to support and retain a pot against the vertical hanger. A pot retaining pad is positioned adjacent the top portion of the device and intended to rest inside the rim of the pot to retain it against the vertical hanger. The device may be further equipped with retaining straps which can hold the pot on the pot support pad to avoid damage from wind and movement.

The pot can be equipped with vent or root-access holes to provide drainage, and to provide direct access to the root structure of the plants within the pot.

An alternative embodiment includes an adjustable rim holder that may be raised or lowered on the vertical hanger to accommodate pots having different heights. This adjustable holder may be spring loaded to engage a series of grooves formed in the vertical hanger, or it may be friction based with a spring tab that secures the rim holder in place.

An apparatus designed to securely hang any size pot to all types of fences, for the purpose of growing flowers or various vegetable plants off the ground and in confined areas. The fence pot hanger can be manufactured to a preset pot size with no adjustments, or can be manufactured with an adjustable spring rim holder that fits and slides over the top hanger main body and locks at a desired height to accommodate larger or small pots. By pushing the spring lever back, causes the pot rim holder to move up or down and firmly secures the rim holder inside the pot. There are additional holes in the main fence pot hanger to provide secure anchor by way of securing the pot to the hanger main body using nylon straps or other means while providing additional drain holes to the pot. This can prevent accidental mishaps when accidentally nudged or possibly strong winds.

### BRIEF DESCRIPTION OF THE FIGURES

The nature, objects, and advantages of the present invention will become more apparent to those skilled in the art after considering the following detailed description in connection with the accompanying drawings, in which like reference numerals designate like parts throughout, and wherein:

FIG. 1 is a side view of the plant pot hanger of the present invention showing the vertical support formed to accept fence, wall and gate structures having various thicknesses, and a pot support pad that supports the pot from the bottom, and a retaining pad that holds the pot securely against the vertical support;

FIG. 2 is a bottom perspective view of the plant pot hanger of the present invention showing the pot support pad, the pot rim retaining pad, and the vertical support that includes a wall-receiving hook for various sized walls and fences;

FIG. 3 is a side view of an alternative embodiment of the plant pot hanger of the present invention showing a movable pot retaining tab that can be raised and lowered by pushing a spring-loaded tab to disengage the ratchet from the vertical support, and showing placement over a tubular fence rail, such as a chain link fence;

FIG. 4 is a top view of the movable pot retaining tab as engaged onto the vertical support of FIG. 3;

FIG. 5 is a perspective view of the movable pot retaining tab as shown removed from the vertical support;

FIG. 6 is a detail view of the spring-loaded retaining tab as engaged onto the vertical support to retain the pot retaining tab in the proper location;

FIG. 7 is a top perspective view of the plant pot hanger of the present invention showing the placement of the pot retaining tab inside the upper edge of the pot and extending from the vertical support;

FIG. 8 is a bottom perspective view of the plant pot hanger of the present invention showing the placement of the pot on the pot support pad;

FIG. 9 is a perspective view of the pot retaining tab of FIG. 1 showing the rounded edges to contact and provide a retaining pressure to maintain the pot against the vertical support;

FIG. 10 is a perspective view of the pot support pad of the plant pot hanger of the present invention;

FIG. 11 is a perspective view of the vertical support of the plant pot hanger of the present invention showing the strengthening ribs and mounting tab for attaching the pot retaining tab;

FIG. 12 is a side view of the plant pot hanger of the present invention showing the placement of a pot on the pot support pad and held in place by the pot retaining tab, and showing the tie support holes formed in the vertical support to secure the vertical support to the fence, and to secure the pot to the vertical support;

FIG. 13 is a top view of an alternative embodiment of the plant pot hanger of the present invention showing a different mechanism for the adjustable pot retaining tab;

FIG. 14 is a side view of the upper portion of the vertical support of FIG. 13;

FIG. 15 is an exploded view of the adjustable pot retaining tab with the spring omitted for clarity;

FIG. 16 is a side view of the plant pot hanger of the present invention of FIGS. 13-15, showing the vertical support having the adjustable pot retaining tab slidably mounted to the support to accommodate pots having different heights.

### DETAILED DESCRIPTION

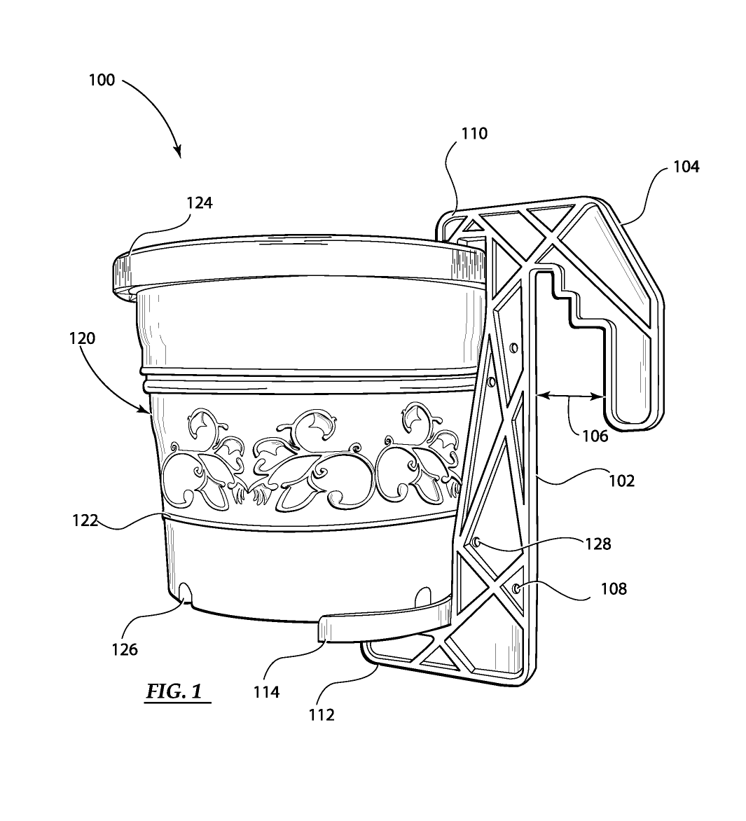

Referring initially to FIG. 1, a side view of the plant pot hanger of the present invention is shown and generally designated 100. The vertical support 102 has an upper portion 104 formed to accept fence, wall and gate structures having various thicknesses 106. A number of tie support holes 108 may be formed in support 102 to assist with securing the device in place on a wall or fence. An upper arm 110 attaches to a pot retaining pad (not shown this Figure) and a pot support arm 112 has a pot support pad 114 that supports the pot 120 from the bottom. Pot 120 includes a bucket portion 122 having a rim 124 and formed with one or more drain or root access holes 126.

As shown in FIG. 1, the pot 120 is securely held in place against vertical support 102 by the pot retaining pad (not shown), and the pot support pad 114. A number of pot tie support holes 128 may be formed in support 102 to tie the pot to the vertical support 102 to provide increased resistance to wind and motion.

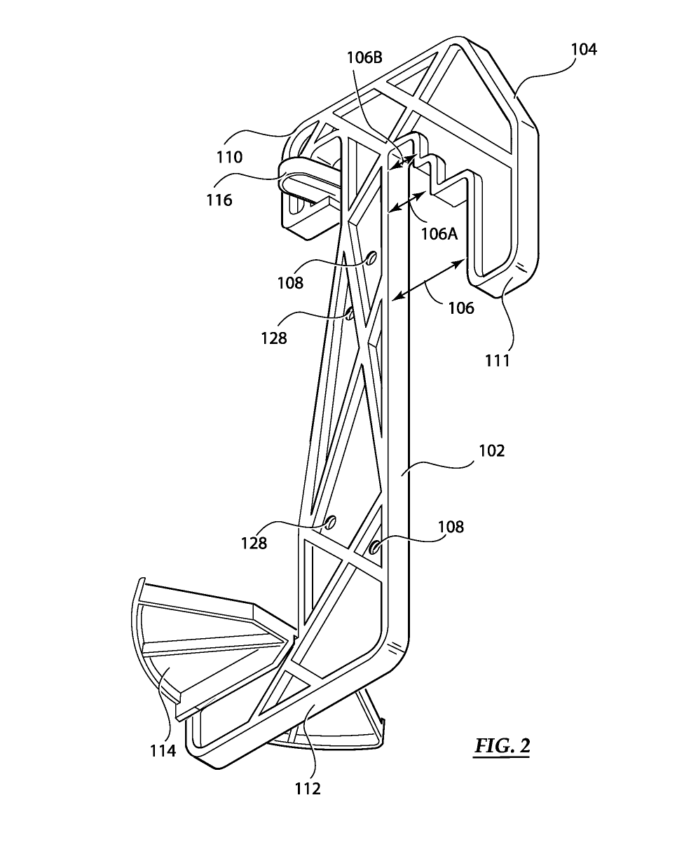

Referring to FIG. 2, a bottom perspective view of the plant pot hanger 100 of the present invention shows the pot support pad 114, the pot rim retaining pad 116, and the vertical support 102 that includes a wall-receiving hook 111 for various sized walls and fences. Specifically, a wall-receiving gap 106 is shown, with a smaller gap 106A and an even smaller gap 106B allows the present invention to be mounted to virtually any thickness wall or fence structure.

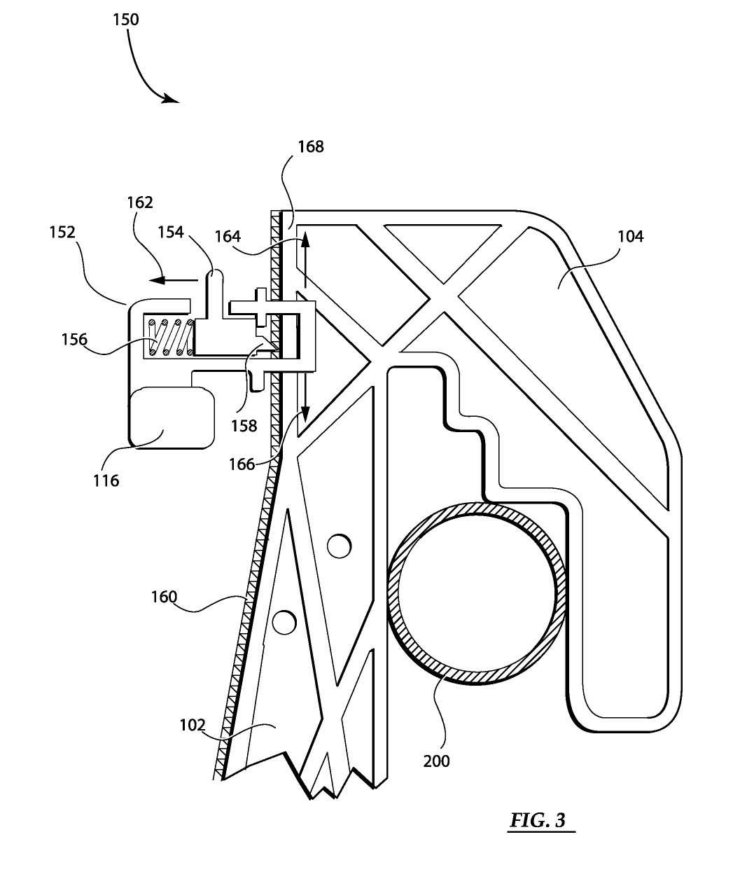

FIG. 3 is a side view of an alternative embodiment of the plant pot hanger of the present invention generally designated 150. Device 150 includes a movable pot retaining tab 152 that can be raised in direction 164 and lowered in direction 166 by pushing spring-loaded tab 154 in direction 162 to compress spring 156 and disengage the ratchet 158 from the grooves 160 formed on vertical support 102. In this manner, the retaining tab 152 can be raised or lowered to accommodate just about any sized pot.

From this figure, it is shown that the vertical support may be placed over a tubular fence rail 200, such as a chain link fence. It is also to be appreciated that the present invention may be installed on fences, walls, doors, cubicle walls, or just about anything else that the hook 104 will mount over.

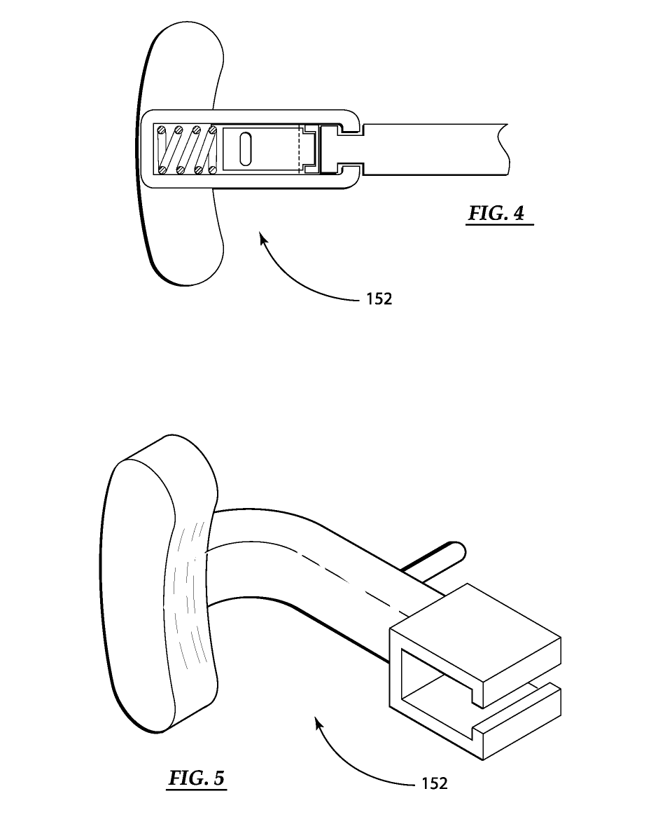

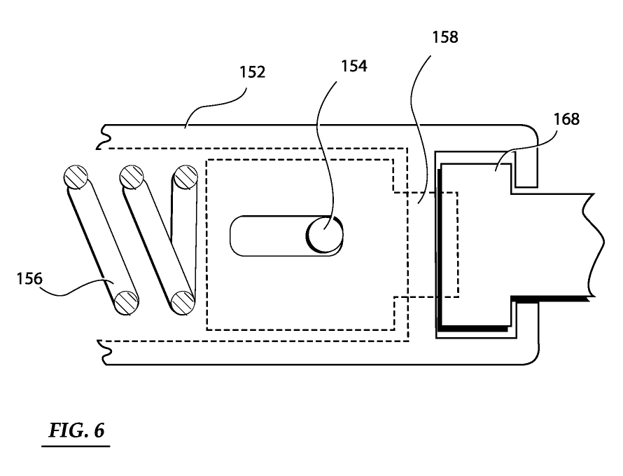

FIG. 4 is a top view of the movable pot retaining tab 152 as engaged onto the vertical support of FIG. 3, and FIG. 5 is a perspective view of the movable pot retaining tab 152 as shown removed from the vertical support. FIG. 6 is a detail view of the movable pot retaining tab 152, showing the spring-loaded retaining tab 158 as engaged onto the ridge 168 of the vertical support 102 to retain the pot retaining tab in the proper location.

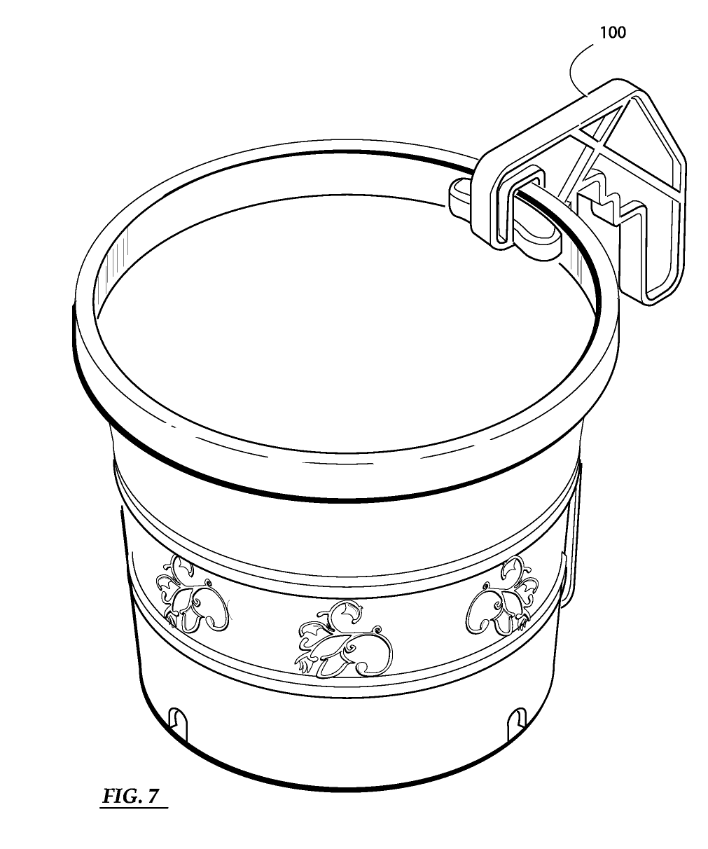

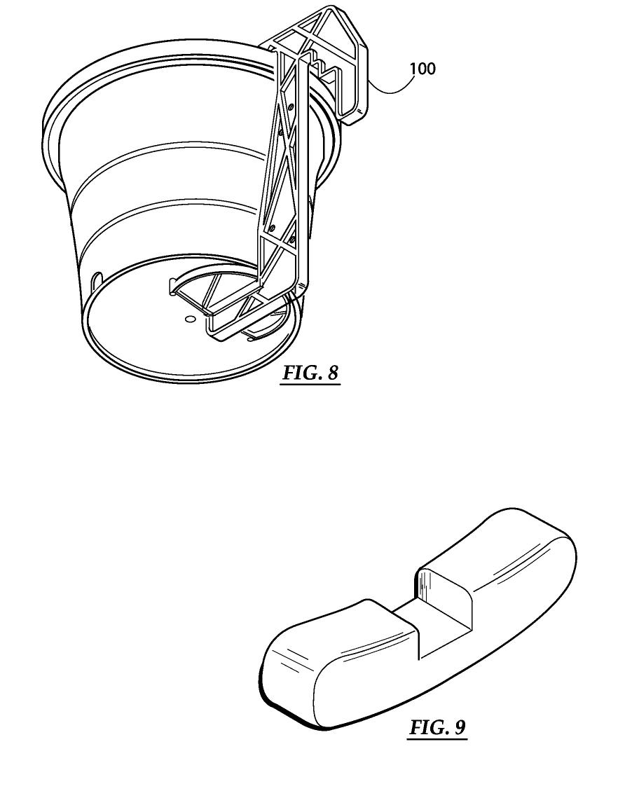

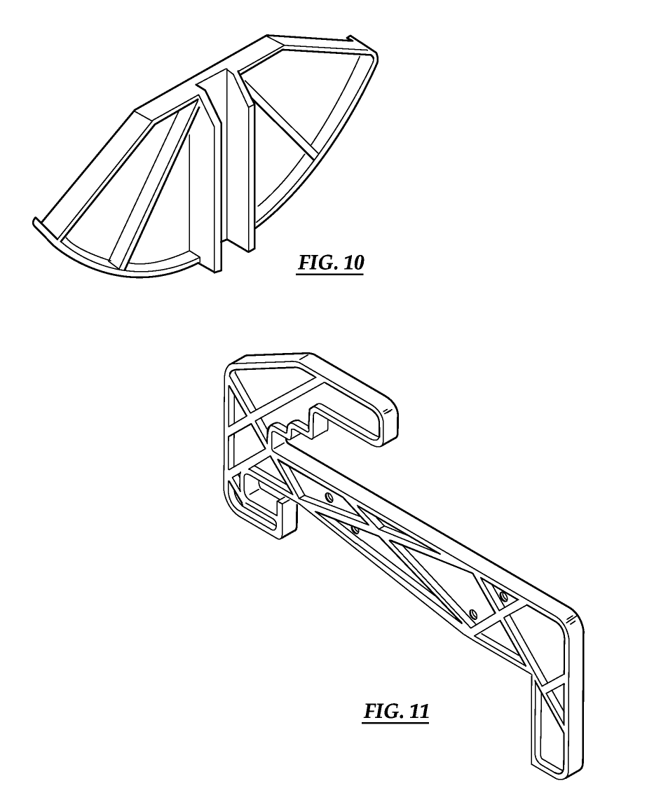

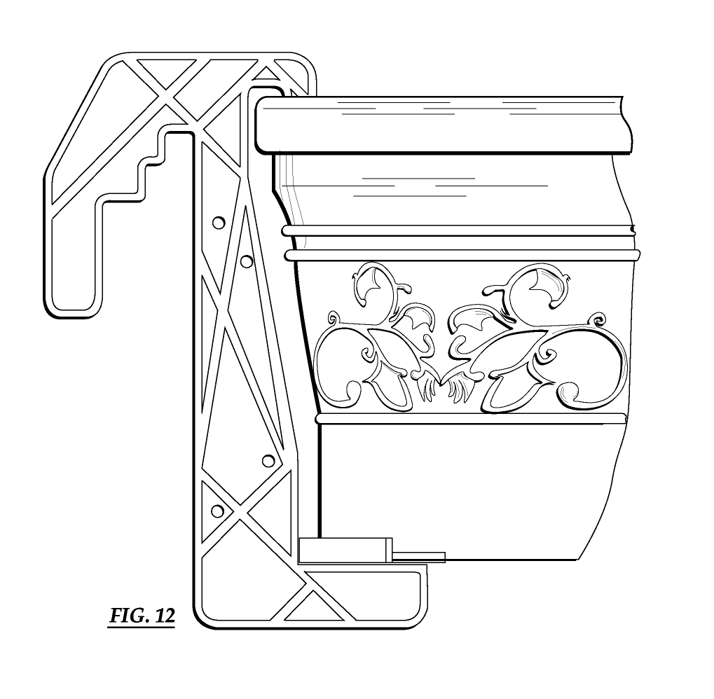

FIG. 7 is a top perspective view of the plant pot hanger 100 of the present invention showing the placement of the pot retaining tab inside the upper edge of the pot and extending from the vertical support. FIG. 8 is a bottom perspective view of the plant pot hanger 100 of the present invention showing the placement of the pot 120 on the pot support pad 114. FIG. 9 is a perspective view of the pot retaining tab 116 of FIGS. 1 and 2 showing the rounded edges to contact and provide a retaining pressure to maintain the pot 120 against the vertical support 102. FIG. 10 is a perspective view of the pot support pad 114 of the plant pot hanger of the present invention. FIG. 11 is a perspective view of the vertical support 102 of the plant pot hanger 100 of the present invention showing the strengthening ribs 150 (see FIG. 2) and mounting tab 110 for attaching the pot retaining tab 116.

FIG. 12 is a side view of the plant pot hanger 100 of the present invention showing the placement of a pot 120 on the pot support pad 114 and held in place by the pot retaining tab 116, and showing the tie support holes 108 formed in the vertical support 102 to secure the vertical support 102 to the fence, and tie support holes 128 to secure the pot to the vertical support.

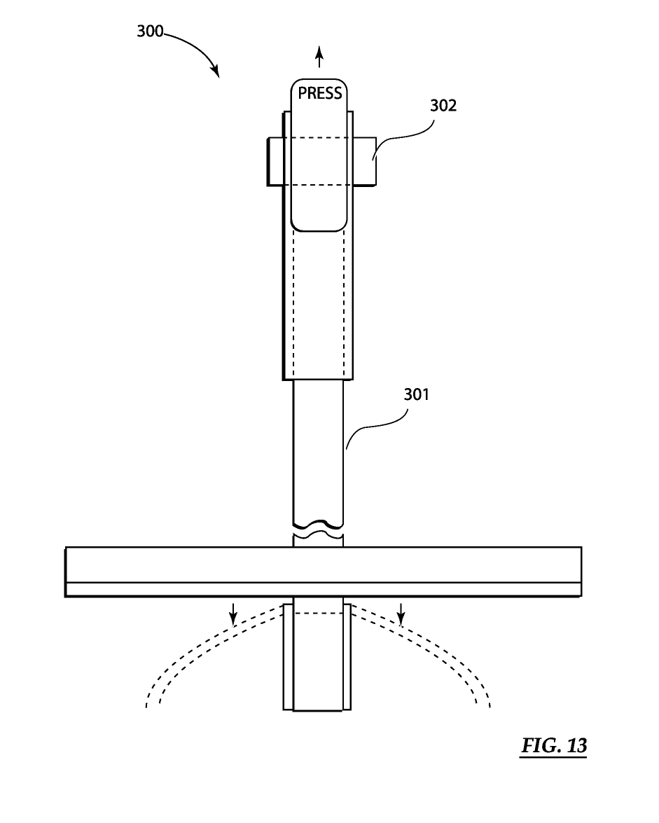

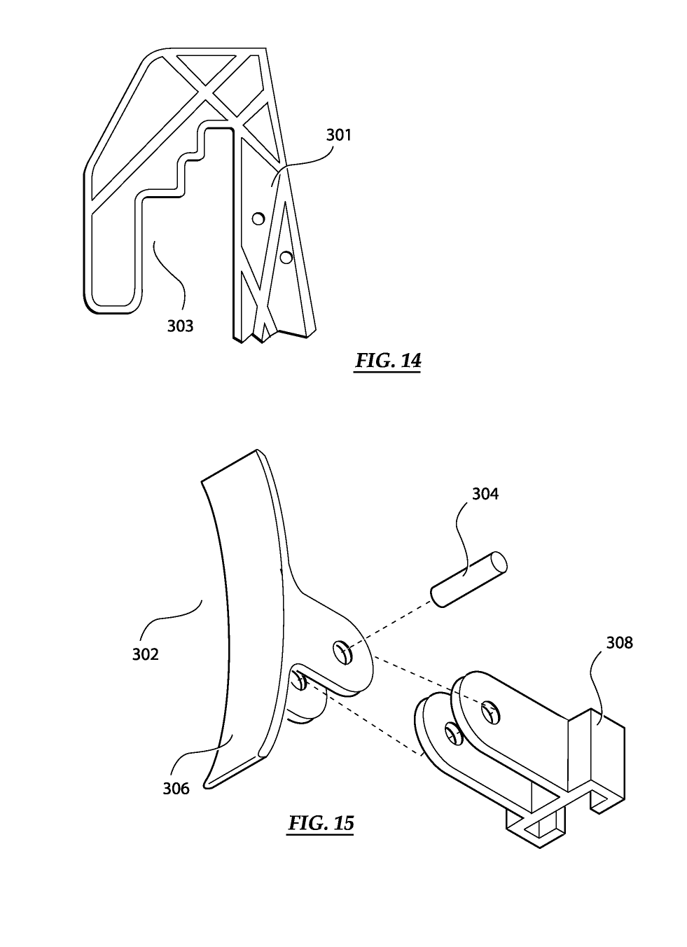

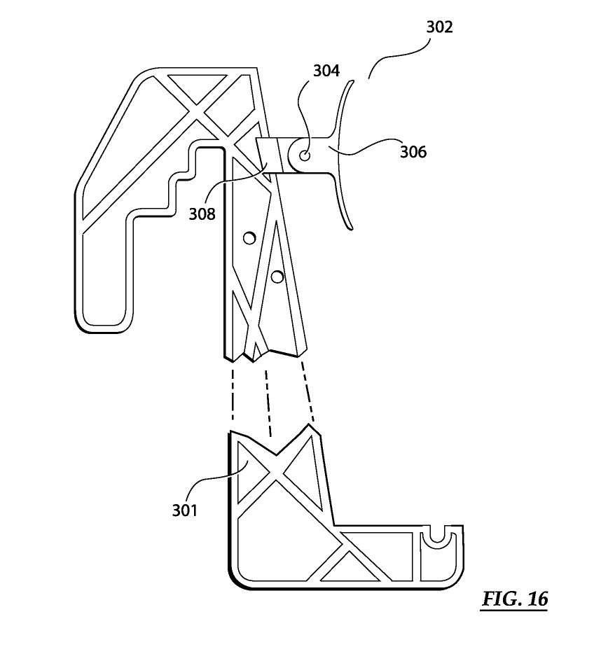

FIG. 13 is a top view of an alternative embodiment of the plant pot hanger of the present invention generally designated 300. Hanger 300 includes an adjustable pot retaining tab 302 that includes a spring loaded clip which can be raised and lowered on the support 301. From FIG. 14, the side view of the upper portion 303 of the vertical support 301 is sized to accept fences and walls as with prior embodiments. FIG. 15 shows an exploded view of the adjustable pot retaining tab 302 having a spring loaded clip 306 (with the spring omitted for clarity) and a slide 308, and a retaining pin 304 that holds the clip 306 and slide 308 together. FIG. 16 shows a side view of the plant pot hanger 300 of the present invention shown in FIGS. 13-15, and demonstrates the vertical support 301 having the adjustable pot retaining tab 302 slidably mounted to the support 301 to accommodate pots having different heights.

The plant pot hanger of the present invention is unlike any conventional gardening; it requires virtually no weeding, no bending, or heavy cultivating. Because the plants are located high above the ground on fences, walls, posts, etc., pests cannot easily access plants. Also, because the soil is contained and accessible through ports in the pot, the user can fertilize directly into the root structure of the plants.

While there have been shown what are presently considered to be preferred embodiments of the present invention, it will be apparent to those skilled in the art that various changes and modifications can be made herein without departing from the scope and spirit of the invention.

1. A plant pot hanger, comprising:
a vertical support having an upper portion formed with a wall-receiving hook that defines a receiving gap;
a pot support [[pad]] arm extending from said vertical support sized to support a portion of a pot: and
an upper arm extending from said upper portion of said vertical support to retain a pot on said pot support arm and adjacent said vertical support.

2. The plant pot hanger of claim 1, wherein said vertical support is formed with at least one support tie hole.

3. The plant pot hanger of claim 1, wherein said wall-receiving hook defines a plurality of receiving gaps.

4. The plant pot hanger of claim 1, wherein said vertical support is formed with at least one pot tie support hole.

5. The plant pot hanger of claim 1, further comprising a pot support pad adjacent said pot support arm to support a pot.

6. The plant pot hanger of claim 1, further comprising a pot retaining pad adjacent said upper arm and positioned to contact the rim of said pot wherein said rim of said pot is positionable between said pot retaining pad and said vertical support.

7. The plant pot hanger of claim 1, wherein said pot support arm further comprises:
a movable pot retaining pad adjacent said upper arm and positioned to contact the rim of said pot wherein said rile of said pot is retained between said pot retaining pad and said vertical support; and
a means for raising and lowering said pot retaining pad along said vertical support.

8. The plant pot hanger of claim 7, wherein said means for raising and lowering said pot retaining pad further comprises:
said vertical support formed with a plurality of grooves; and
said movable pot retaining tab having a ratchet engagable with said grooves to retain said movable pot retaining tab in position on said vertical support.

9. A plant pot hanger, comprising:
a vertical support having an upper portion formed with a receiving hook that defines a receiving gap;
a pot support arm extending from said vertical support sized to support a portion of a pot; and
a movable pot retaining tab slidable along said vertical support and extending from said vertical support, said movable pot retaining tab having a pot retaining pad to contact said pot and retain said pot on said pot support and adjacent said vertical support.

10. The plant pot hanger of claim 9, further comprising:
said vertical support formed with a plurality of grooves; and
said movable pot retaining tab having a ratchet engagable with said grooves to retain said movable pot retaining tab in position on said vertical support.

11. The plant pot hanger of claim 10, further comprising:
said movable pot retaining tab having a spring-loaded tab extending from said ratchet;
a spring positioned within said movable pot retaining tab to urge said ratchet against said grooves; and
wherein movement of said spring-loaded tab to compress said spring disengages said ratchet from said grooves allowing movement of said movable pot retaining tab along said vertical support.

12. The plant pot hanger of claim 9, wherein said vertical support is formed with at least one support tie hole.

13. The plant pot hanger of claim 9, wherein said wall-receiving hook defines a plurality of receiving gaps.

14. The plant pot hanger of claim 9, wherein said vertical support is formed with at least one pot tie support hole.

15. A plant pot hanger, comprising:
a vertical support having an upper portion formed with a receiving hook that defines a receiving gap;
a pot support arm extending from said vertical support sized to support a portion of a pot;
an upper arm extending from said upper portion of said vertical support to retain said pot on said pot support and adjacent said vertical support; and
a pot, said pot having a base, a sidewall extending from said base and formed with an upper rim, wherein said base is positioned on said pot support arm, and said rim is captured between said upper arm and said vertical support to retain said pot adjacent said vertical support.

16. The plant pot hanger of claim 15, wherein said vertical support is formed with at least one support tie hole.

17. The plant pot hanger of claim 15, wherein said receiving hook defines a plurality of receiving gaps.

18. The plant pot hanger of claim 15, wherein said vertical support is formed with at least one pot tie support hole.

19. The plant pot hanger of claim 15, further comprising a pot retaining pad adjacent said upper arm and positioned to contact the rim of said pot wherein said rim of said pot is positionable between said pot retaining pad and said vertical support.

20. The plant pot hanger of claim 15, further comprising a pot support pad adjacent said pot support arm to support a portion of said base of said pot.
